(19) United States
(12) Patent Application Publication
(10) Pub. No.: US 2020/0095037 A1
(43) Pub. Date: Mar. 26, 2020

(54) CONTAINER WITH INTEGRATED MANUAL STIRRING DEVICE

(71) Applicant: Kimberly Lynn Amos, Murrieta, CA (US)

(72) Inventor: Kimberly Lynn Amos, Murrieta, CA (US)

(21) Appl. No.: 16/681,195

(22) Filed: Nov. 12, 2019

Related U.S. Application Data
(60) Provisional application No. 62/771,735, filed on Nov. 27, 2018.

(51) Int. Cl. B65D 51/32; B01F 13/00; B65D 45/20

(52) U.S. Cl. CPC B65D 51/32; B65D 23/04; B65D 45/20; B01F 13/0022

(57) ABSTRACT

The present invention relates to container with an integrated manual stirring device (100) comprising a cork lid (101) with an outer surface and an inner surface; a stirring stick (102) and a groove (103) which is adapted in base of the stirring stick (102) wherein the lid (101) narrows out to the stirring stick (102) inside the container i.e. jar (105), when the lid (101) is sit on the container top rim and securely fastened using clamps (104) which is come up from a metal ring (106) around the neck of the container (105) such that the lid (101) can be clamped on to internal neck of the container (105) providing an airtight seal to preserve contents where the contents flow down the stirring stick (102) and settle while the container (105) is open and the lid (101) is upside down.

### FIELD OF THE INVENTION

The present invention relates to a container with an integrated manual stirring device. More particularly, the present invention relates to jar or storage containers for storing organic beauty products which separate overtime and should be stirred prior to each use.

### BACKGROUND AND PRIOR ART

This application relates to jars, such as food jars, or other storage containers that may use lids that are screwed on via threaded connections. Such that the jars or storage containers are often used for long term storage and to keep air from entering the container.

Generally, coffee and other beverages are available in so-called ‘take-away’ or ‘take-out’ containers. Such the containers consist of a cup or receptacle, with a lid. The cup and lid are commonly made from a material such as cardboard, waxed paper, plastic, Styrofoam™ or some other form of formable yet inexpensive material. Such cups and lids are generally made in a way to allow for easy disposal.

Accordingly, this container is common for people to purchase take-away coffee, tea or other hot beverages for consumption while they are walking, travelling in a vehicle or otherwise moving from one location to another. In such circumstances, the lid prevents the beverage from spilling out of the container as the person moves or as their vehicle moves. However, where a take-away container includes the lid, such that the lid must be removed to add other ingredients, such as liquids or solids to the beverage (e.g. adding milk and sugar to coffee). Moreover, when another liquid or solid is added to the beverage, it is commonly necessary to stir the beverage to mix the added ingredients into the beverage.

Typically, long term storage of liquid or semi-liquid contents can result in the separation of component parts of the contained matter. For example, ‘natural peanut butter’ can have some of the oil contained inside of it separate out and form an oil layer near the top of the jar or storage container. Once the container is opened, it is then necessary to stir and mix the contents in order to homogenize the food or other product. Since such containers are usually full of the substance or product, it can often be difficult and messy to attempt to do the stirring or mixing inside the container once the lid has been removed. Options are unsatisfactory and include creating a mess or transferring the entire contents of the jar or storage container in order to mix the contents.

Where the people are carrying the beverages or the beverage is in a vehicle that is moving, removing the lid can be awkward and give rise to a dangerous situation, particularly if the beverage spills and is hot.

There are few prior art documents related to the storage container with stir mechanism. The prior art document US20150103622A1, assigned to individual inventors. The prior art document relates to a jar or other storage container with an integrated stirring device, where the contents of the jar or storage container can be stirred and mixed together without having to completely open the jar or storage container. The core components in one embodiment are a top portion that contains external threads, a lid portion which contains internal threads, a spindle with an etched self-reversing screw pattern, a hub, one or more stirring blades, and a nut. The stirring blades have one end attached at a hub that is free to rotate on the spindle, the other end is attached to a nut that can travel up and down the self-reversing screw pattern, and the spindle is fixed to the lid portion. The surface area of the stirring blade(s) can be changed to accommodate different thicknesses and viscosities of different fluids and semi-fluids placed in the storage container.

Another prior art document US20160280430A1 assigned to COGITO ET CREO LTD. The document relates to a lid for a container includes an attachment portion arranged to attach the lid to the container. There is a lid portion integrally formed with the attachment portion and sized to substantially cover an opening in the container. It also includes at least one opening located on the lid portion to allow the ingress or egress of fluid from the container when the lid is in situ, and at least one arm extending from the lid portion and arranged, in use, to locate within the container to stir the contents of the container.

Yet another prior art document US200.70291585A1, assigned to XTRAORDINARY HOME PRODUCTS LLC. The document relates to a pitcher assembly having a pitcher body is provided. The pitcher body has a handle and lid assembly. The lid assembly may comprise a lid body and a mixing rod extending downward from the lid. The mixing rod may include one or more mixing leaves. The mixing rod may be adapted to rotate to stir the contents of the pitcher. The actuation of the mixing rod may be via a plunger assembly that operates a one-way clutch mechanism, such that operating the plunger assembly causes the mixing rod to rotate in the pitcher.

In order to solve the above mentioned prior art problems, to provide the jar or storage container for storing organic beauty products which separate overtime and should be stirred prior to each use.

The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE INVENTION

One or more drawbacks of conventional container with stirring device and additional advantages are provided through the present invention relates to jar or storage container with a lid which can be used as a manual stirring device after unscrewing the lid to stir jar contents. Additional features and advantages are realized through the technicalities of the present disclosure. Other embodiments and aspects of the disclosure are described in detail herein and are considered to be a part of the claimed disclosure.

In an embodiment of the present invention relates to container with a lid which can be used as a manual stirring device after unscrewing the lid to stir container contents. The container i.e. jar or beauty jar, with an integrated manual stirring device comprising a cork lid having an outer surface and an inner surface wherein the lid narrows out to stirring stick inside the container when the lid is fastened using clamps on to the container without extending outside the cork lid and the container such that the lid can be clamped on to internal neck of the container providing an airtight seal to preserve contents where the contents flow down the stirring stick and settle while the container is open and the lid is upside down.

It is to be understood that the aspects and embodiments of the disclosure described above may be used in any combination with each other. Several of the aspects and embodiments may be combined to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

It is to be noted, however, that the appended drawings illustrate only typical embodiments of the present subject matter and are therefore not to be considered for limiting its scope, for the invention may admit to other equally effective embodiments. The detailed description is written with reference to the accompanying figures. In the figures, the left-most digit(s) of a reference number identifies the figure in which the reference number first appears. The same numbers are used throughout the figures to reference the like features and components. Some embodiments of system or methods in accordance with embodiments of the present subject matter are now described, by way of example, and with reference to the accompanying figures, in which:

FIG. 1 illustrates schematic view of jar or storage container with lid, in accordance with an embodiment of the present subject matter;

FIG. 2 illustrates schematic view of lid open position in jar or storage container, in accordance with an embodiment of the present subject matter; and

FIG. 3 illustrates schematic view of stirring stick inside the jar or storage container, in accordance with an embodiment of the present subject matter.

The figures depict embodiments of the present subject matter for the purposes of illustration only. A person skilled in the art will easily recognize from the following description that alternative embodiments of the structures and methods illustrated herein may be employed without departing from the principles of the disclosure described herein.

### DETAILED DESCRIPTION OF THE INVENTION

While the embodiments of the disclosure are subject to various modifications and alternative forms, specific embodiments thereof have been shown by way of example in the figures and will be described below. It should be understood, however, that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof used in the disclosure, are intended to cover a non-exclusive inclusion, such that a device, system, assembly that comprises a list of components does not include only those components but may include other components not expressly listed or inherent to such system, or assembly, or device. In other words, one or more elements in a system or device proceeded by “comprises . . . a” does not, without more constraints, preclude the existence of other elements or additional elements in the system or device.

An embodiment of the present invention relates to the container for storing organic beauty products which separate overtime and should be stirred prior to each use.

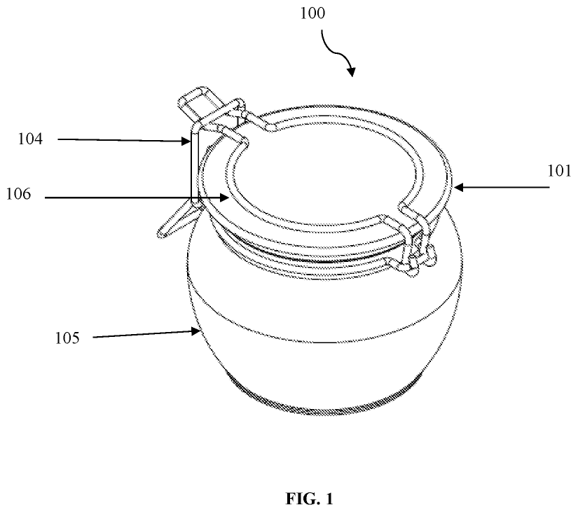

As shown in FIG. 1 illustrating schematic view of jar or storage container with lid, in accordance with an embodiment of the present subject matter. The container i.e. Stoneware jar or beauty jar, with an integrated manual stirring device 100 comprising a cork lid 101 having an outer surface and an inner surface; a stirring stick 102 and a groove 103 which is adapted in base of the stirring stick 102.

Accordingly, the cork lid 101 narrows out to the stirring stick 102 inside the jar 105 when the cork lid 101 is clamped on to the jar 105 using clamps 104 without extending outside the cork lid 101 such that the lid 101 can be sit on the jar top rim and be securely fastened using the clamps 104 which will come up from a metal ring 106 around the neck of the jar providing an airtight seal to preserve contents where the contents flow down the stirring stick 102 and settle while the jar 105 is open and the lid 101 is upside down.

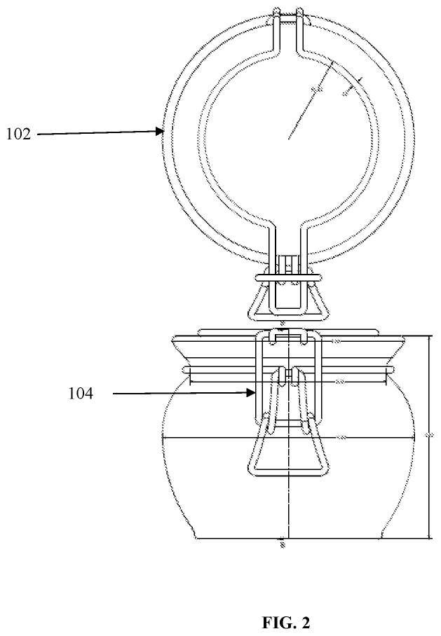

As shown in FIG. 2 illustrating schematic view of lid open position in jar or storage container, in accordance with an embodiment of the present subject matter. The cork lid 101 is matched with the jar or storage container 105 shown in FIG. 1. The cork lid 101 consists of the following components: an outer surface and an inner surface, a central stirring stick 102 with a screw pattern etched into the lower half, one or more flexible stirring. The stirring stick 102 and the lid 101 can be made of metal, plastic, or other materials that are known in the art.

Accordingly, the cork lid 101 has provided with airtight seal which includes metal ring 106 that is placed around the neck of the jar 105; and a clamping collar by clamping the cork lid 101 and the groove 103 is adapted on base of the stirring stick 102 which is detachably attached to the lid 101 of the jar 105.

In such view of the cork lid 101 is provided with extended stirrer that is 100% cork will rest on top of the jar rim. The base of the lid 101 is flat with the groove 103 where the stirring stick 102 begins to extend from the lid 101 so that after stirring, contents can run down the stirring stick 102 and settle in the groove 103 when the lid 101 is upside down. The flat base of the lid 101 which sits on the jar rim allows the stirring stick 102 to reach to the bottom of the jar 105 so all contents can be reached and stirred. When not in use, the lid 101 stirrer is securely fastened with the clamps 104 which results in an airtight seal closing arrangement. The clamps 104 are constructed with metal or other suitable materials.

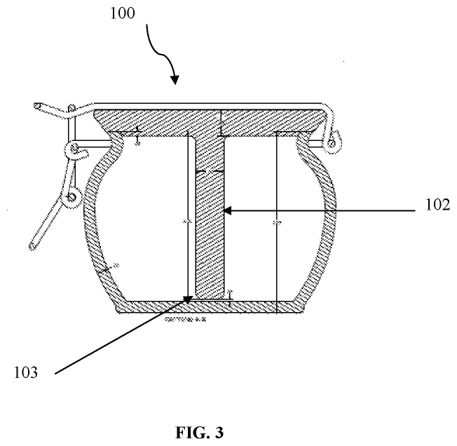

As shown in FIG. 3 illustrating schematic view of stirring stick inside the jar or storage container, in accordance with an embodiment of the present subject matter. Top of stirring stick 102 is rigidly attached to the bottom centre of the inside lid 101 for flexible manual stirring the contents in the jar or storage container 105 after unscrewing the lid 101. This jar or storage container 105 with integrated stirring device 100 is not limited to these embodiments but also includes other embodiments where the surface area of the stirring stick 102 is increased in order to create more back-pressure from the fluid or semi-fluid contained in the storage container 105, as shown in FIG. 1.

Further, these components are limited with height and width as follow: the height of the jar or storage container 105 with the lid 101 is at 4.5 inches, and without the lid 101 is at 4 inches. The width of jar 105 is at 4.5 inches. The width neck portion of jar 105 is at 3.5 inches, and the width of jar 105 top portion is at 4 inches. The length of stirring stick 102 is at 3.75 inches, the width of stirring stick 102 is at 0.50 inches, and width midline of stirring stick 102 is at 3.25 inches.

In accordance with an embodiment of the present invention provides a lid base that closes into the jar which results in a slight gap between an end of the stirring stick and the bottom of the jar when the lid is open and stirring contents. Further, the present invention provides 100% cork lid/stirrer which will push down into the jar resulting in an airtight close.

In addition, the present invention is not limited to the cork lid as well as bamboo lid/stirrer with silicone ring around the middle of the lid will push down into the jar resulting in an airtight close, also metal clamps will extend from a metal ring (106) around the neck of the jar when clamped and rest on the ring (106) when unclamped, and the bamboo lid/stirrer with and/or without the silicone ring will screw into the jar threads to provide the airtight close.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

Although embodiments for the present subject matter have been described in language specific to structural features, it is to be understood that the present subject matter is not necessarily limited to the specific features described. Rather, the specific features and methods are disclosed as embodiments for the present subject matter. Numerous modifications and adaptations of the system/component of the present invention will be apparent to those skilled in the art, and thus it is intended by the appended claims to cover all such modifications and adaptations which fall within the scope of the present subject matter.

What is claimed is:

1. A container with an integrated manual stirring device (100) comprising:
a cork lid (101) having an outer surface and an inner surface;
a stirring stick (102); and
a groove (103) which is adapted in base of said stirring stick (102);
wherein said cork lid (101) narrows out to said stirring stick (102) inside said container (105) when said cork lid (101) is sit on said container top rim and securely fastened using clamps (104) such that said cork lid (101) can be clamped on to internal neck of said container (105) providing an airtight seal to preserve contents where said contents flow down said stirring stick (102) and settle while said container is open and said cork lid (101) is upside down.

2. The container with an integrated manual stirring device (100) as claimed in claim 1, wherein said container (105) is Stoneware jar or beauty jar.

3. The container with an integrated manual stirring device (100) as claimed in claim 1, wherein said cork lid (101) is securely fastened using said clamps (104) which come up from a metal ring (106) around neck of said container (105).

4. The container with an integrated manual stirring device (100) as claimed in claim 1, wherein height of said container (105) with said cork lid (101) is at 4.5 inches, and without said cork lid (101) is at 4 inches.

5. The container with an integrated manual stirring device (100) as claimed in claim 1, wherein width of said container (105) is at 4.5 inches.

6. The container with an integrated manual stirring device (100) as claimed in claim 1, wherein neck width of said container (105) is at 3.5 inches.

7. The container with an integrated manual stirring device (100) as claimed in claim 1, wherein width of top container (105) is at 4 inches.

8. The container with an integrated manual stirring device (100) as claimed in claim 1, wherein length of said stirring stick (102) is at 3.75 inches.

9. The container with an integrated manual stirring device (100) as claimed in claim 1, wherein width of said stirring stick (102) is at 0.50 inches.

10. The container with an integrated manual stirring device (100) as claimed in claim 1, wherein width midline of said stirring stick (102) is at 3.25 inches.

11. The container with an integrated manual stirring device (100) as claimed in claim 1, wherein said stirring stick (102) is made of metal, plastic and other suitable materials.

12. The container with an integrated manual stirring device (100) as claimed in claim 1, wherein said clamps (104) are made of metal or other suitable materials.
